(19) United States
(12) Patent Application Publication
(10) Pub. No.: US 2024/0314139 A1
(43) Pub. Date: Sep. 19, 2024

(54) SECURE VEHICLE COMMUNICATION NETWORKS AND DYNAMIC INTERVEHICLE COMPLIANCE

(71) Applicant: International Business Machines Corporation, Armonk, NY (US)

(72) Inventors: Sudheesh S. Kairali, Kozhikode (IN); Sarbajit K. Rakshit, Kolkata (IN); Manish Anand Bhide, Hyderabad (IN); Murali Vasudev, Bangalore (IN)

(21) Appl. No.: 18/183,192

(22) Filed: Mar. 14, 2023

(51) Int. Cl. H04L 9/40; G06F 8/65

(52) U.S. Cl. CPC H04L 63/107; G06F 8/65; H04L 63/20

(57) ABSTRACT

Computer-implemented methods, systems and program products establishing dynamically compliant and secure vehicle communication networks. Software bill of materials (SBOMs) are leveraged by route mapping services or other applications to ensure vehicle components and dependencies thereof comply with locational policies along a vehicle's route, as well as individual vehicle policies required to engage in vehicle-to-vehicle communications. Vehicle SBOMs are fetched and compared to policies for each location or zone a vehicle may pass through during a trip. Applicable policies can be set by government, or other institutions. Vehicles failing to comply with global policies of locations can be prevented from communicating or connecting to vehicle networks or may be re-routed to avoid locations where compliance is not achieved. Vehicles failing to meet the level of compliance required by individual vehicle policies may be prevented from conducting intervehicle communications with the vehicle requiring the particular level of compliance.

### BACKGROUND

The present disclosure relates generally to network security, and more specifically establishing network security and compliance of vehicles creating or connecting to vehicular networks enabling intervehicle communications.

Intervehicle communication networks (IVCNs) are a type of wireless networks that enable communication between vehicles on the road. IVCNs can be designed to support a variety of safety and efficiency applications made available to the vehicles communicating via the IVCN. A typical IVCN may implement a communication protocol such as Dedicated Short-Range Communications (DSRC) or Cellular Vehicle-to-Everything (C-V2X). DSRC may refer to a wireless communication standard that operates on a frequency band reserved for intelligent transportation systems, while C-V2X can use cellular networks to enable communication between vehicles and other connected devices.

The use of IVCNs can provide several benefits that improve vehicle safety and efficiency, including applications that provide features such as collision avoidance, cooperative adaptive cruise control, platooning and road hazard warning. Collision avoidance allows vehicles to exchange information about their speed, location, and direction of travel, allowing them to detect and avoid potential collisions. Cooperative adaptive cruise control allows vehicles to communicate with each other to adjust their speed and maintain a safe following distance, reducing congestion and improving traffic flow. Platooning allows groups of vehicles to travel together in a closely spaced formation, with the lead vehicle controlling the speed and direction of the entire platoon. This can improve fuel efficiency and reduce congestion. Road hazard warning applications allow vehicles connected to an IVCN to alert each other about the presence of road hazards including accidents or obstacles, enabling drivers or autonomous vehicles to take appropriate actions or implement evasive maneuvers.

### SUMMARY

Embodiments of the present disclosure relate to computer-implemented methods, associated computer systems and computer program products for establishing secure vehicle communication networks. The computer-implemented method comprising the steps of fetching, by at least one processor, a software bill of materials (SBOM) documenting software components and dependencies of a vehicle; comparing, by the at least one processor, the SBOM of the vehicle with one or more policies for one or more location, region or zone the vehicle is currently positioned within or routed to travel through; and upon comparing the SBOM of the vehicle with the one or more policies, the vehicle complies with the policies of the one or more location, region or zone, enabling, by the at least one processor, vehicle-to-vehicle communication over the secure vehicle network within the one or more location, region or zone the vehicle complies with the one or more policies.

### BRIEF DESCRIPTION OF THE DRAWINGS

The drawings included in the present disclosure are incorporated into, and form part of, the specification. The drawings illustrate embodiments of the present disclosure and, along with the description, explain the principles of the disclosure. The drawings are only illustrative of certain embodiments and do not limit the disclosure.

FIG. 1 depicts a block diagram illustrating an embodiment of a computer system and the components thereof, upon which embodiments described herein can be implemented in accordance with the present disclosure.

FIG. 2 depicts a block diagram illustrating an extension of the computing system environment of FIG. 1, wherein the computer systems are configured to operate in a network environment (including a cloud environment), and perform methods described herein in accordance with the present disclosure.

FIG. 3 depicts a functional block diagram describing an embodiment of a system for implementing a secure vehicle-to-vehicle communication network, in accordance with the present disclosure.

FIG. 4 depicts a functional block diagram depicting a workflow of an embodiment of a system for implementing a secure vehicle-to-vehicle communication network, in accordance with the present disclosure.

FIG. 5A illustrates a flow diagram describing an embodiment of a method for implementing a secure vehicle-to-vehicle communication network, in accordance with the present disclosure.

FIG. 5B illustrates a continuation of the flow diagram of FIG. 5A, describing the embodiment of the method for implementing a secure vehicle-to-vehicle communication network, in accordance with the present disclosure.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The corresponding structures, materials, acts, and equivalents of all means or steps plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments chosen and described are in order to best explain the principles of the disclosure, the practical applications and to enable others of ordinary skill in the art to understand the disclosure for various embodiments with various modifications as are suited to the particular use contemplated.

### Overview

Vehicular networks promote communications and interactions between vehicles and roadside devices operating along a trajectory on various roadways and highways. Communications between vehicles, over a vehicle network, enable smoother travel and coordination between vehicles. Several factors may influence the interactions between vehicles, including vehicle speed, road conditions, time of day and weather. Moreover, driver behavior and interests can influence vehicle features. Vehicular social networks are beginning to arise as a new perspective on vehicular networks, where the vehicles “socialize” and share common interests. Vehicle networks can classify communication and interactions between vehicles according to the interactions performed, common interests and similar routines. Embodiments of the present disclosure recognize that as software systems of vehicles are being continuously updated, upgraded or adding new devices. If a single vehicle system is compromised, this can lead to a massive compromise of all vehicles that may communicate or interact with the compromised vehicle utilizing a vehicle network while traveling along the compromised vehicle's trajectory. Moreover, some routes of travel may include locations or zones that may require higher levels of compliance with security requirements. Therefore, there is a need for ensuring compliance standards and security levels when vehicles are communicating with one another as they travel along a route or pass through locations that require higher levels of compliance to meet the security policies applied to the surrounding environments.

Embodiments of the present disclosure address the need for establishing secure vehicle-to-vehicle communication networks that dynamically meet compliance and security standards of each vehicle's surrounding environment along a route being travelled and/or the vehicles joining the network. Embodiments of the present disclosure may utilize a map-based routing service or other cloud based applications, with the ability to handle location-based security and compliance policies. Any systems making use of the routing service and route maps may apply compliance and security policies that are validated by the routing service in order to route the vehicle through a particular location and/or enable vehicle-to-vehicle communications. Embodiments may leverage the use of software bill of materials (SBOM) as a policy validator of the route mapping system. SBOM validation tools of the route mapping service can verify and validate the software components and their dependencies (including third-party and open-source software) for each vehicle connected to the routing service; ensuring compliance with the policies of each location, area, zone, etc. (hereinafter referred to generally as “location”) of a vehicle's route and/or vehicle-specific policies of the vehicle establishing the route or vehicles that may communicate therewith. Vehicles with SBOMs that are unable to comply with policies of locations the vehicles are routed through, can be muted or prevented from connecting to a vehicular network while traveling through the particular locations, or in some instances, vehicles may be re-routed to bypass the location where the vehicle is unable to meet the standards prescribed by the location's policy. Likewise, any vehicles unable to comply with another vehicle's policy may be prevented from communicating with said vehicle.

Route mapping services can fetch SBOMs of vehicles. In some embodiments, fetching SBOMs while traveling may not be efficient because of network connectively issues. The route mapping service can fetch SBOMs of vehicles preemptively and may do so on a diff basis. For example, SBOMs may be fetched when a vehicle is switched on and/or connected to the network. Diff SBOMs can be fetched each time updates or upgrades occur and/or upon new devices being plugged in or added to the vehicle. In cases where a vehicle is not regularly updating and/or providing diff SBOMs to the route mapping service for a prolonged period of time, embodiments of the route mapping service can proactively prevent a vehicle from establishing vehicle-to-vehicle communication or connecting to a vehicle network.

Embodiments of the present disclosure may optimize route mapping based on vehicle compliance with the policies enforced by the surrounding locations and environments the vehicle is routed to travel through. For example, when a vehicle is entering a first zone of a route map, the route mapping service can check whether the vehicle is compliant with the policies attached to the first zone. The route mapping service can perform this check by automatically acquiring the SBOM of the vehicle and validating it against the policies of the first zone. If the vehicle is not compliant, the vehicle can be muted and prevented from engaging in vehicle-to-vehicle communication for the duration of the vehicle's travel throughout the first zone. In some situations, inter-vehicle communication may be essential for traveling by the vehicle. For instance, where the vehicle is an autonomous vehicle. Instead of disabling vehicle-to-vehicle communications, route mapping services can reroute the vehicle around the first zone, alert the vehicle owner that further travel through the first zone is not possible, advise the vehicle owner to engage in manual driving without inter-vehicle communication (if possible) and/or advise the owner of the vehicle how to alleviate the policy violations detected within the SBOM. For example, by suggesting updates or upgrades that can place the vehicle in compliance with the policy for the location the vehicle is being routed through.

Embodiments of the present disclosure my implement intelligent software updates or upgrades based on the location of vehicles and/or the vehicle's SBOM, allowing vehicles to upgrade to meet compliance standards for a particular location as well as prevent or delay upgrades depending on the type of location a vehicle is routed through. For example, if an upgrade will make a vehicle compliant with a location, the route mapping service may allow for preemptive upgrades to place the vehicle in compliance before entering a particular location, region or zone. If there is not enough time to upgrade the vehicle preemptively, the route mapping service may adjust the velocity of the vehicle or stop the vehicle before entering the location or zone with the compliance standards that are not met by the vehicle in order to upgrade the vehicle. A successful update or upgrade can allow the vehicle to enter the location without being muted or prevented from engaging in vehicle-to-vehicle communication. Likewise, if preemptive upgrades cannot be applied in time, the route mapping service may change the route, avoiding the location or zone altogether. Furthermore, in some instances where restricted locations or areas having an elevated level of compliance standards are positioned along a vehicle's route, an upgrade or update may actually remove a vehicle's SBOM from compliance. Under such circumstances, upgrades or updates can be delayed or prevented until after a vehicle has passed through the location or zone with strict compliance requirements.

In some embodiment of the present disclosure, the route mapping service may dynamically evaluate inter-vehicles compliance with vehicle-specific standards and policies for engaging in vehicle-to-vehicle communication and/or connecting to vehicle communication networks. When two or more vehicles are trying to engage in vehicle-to-vehicle communication or vehicles are trying to connect to a vehicle network, embodiments of the route mapping service can fetch SBOMs or diff SBOMs attached to each of the vehicles. Route mapping services can check the SBOMs for the vehicles against any vehicle-specific policies that may be attached to the vehicles being communicated with. Once vehicles are deemed compliant with vehicle-specific policies, connection to vehicle networks or vehicle-to-vehicle communication is enabled. Moreover, in some embodiments, aggregated SBOMs may be used to further ensure added security is provided for vehicle-to-vehicle communication and vehicle communication networks. An aggregated SBOM of all vehicles engaging in the intervehicle communication or communication networks can be evaluated by the route mapping service. In some instances, even though individual vehicles are all compliant with standards and policies of a location, an aggregated SBOM may still not be compliant. Such lack of compliance by the aggregated SBOM may be relevant in locations with an elevated or higher level of security requirements. Accordingly, route mapping services may disrupt or prevent intervehicle communication and/or communications over vehicle networks where compliance issues are identified for the aggregated SBOM.

### Computing System

Various aspects of the present disclosure are described by narrative text, flowcharts, block diagrams of computer systems and/or block diagrams of the machine logic included in computer program product (CPP) embodiments. With respect to any flowcharts, the operations can be performed in a different order than what is shown in the flowchart. For example, two operations shown in successive flowchart blocks may be performed in reverse order, as a single integrated step, concurrently, or in a manner at least partially overlapping in time. A computer program product embodiment (“CPP embodiment”) is a term used in the present disclosure that may describe any set of one or more storage media (or “mediums”) collectively included in a set of one or more storage devices. The storage media may collectively include machine readable code corresponding to instructions and/or data for performing computer operations. A “storage device” may refer to any tangible hardware or device that can retain and store instructions for use by a computer processor. Without limitation, the computer readable storage medium may include an electronic storage medium, a magnetic storage medium, an optical storage medium, an electromagnetic storage medium, a semiconductor storage medium, a mechanical storage medium, and/or any combination thereof. Some known types of storage devices that include mediums referenced herein may include a diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination thereof.

A computer-readable storage medium should not be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As understood by those skilled in the art, data is typically moved at some occasional points in time during normal operations of a storage device, such as during access, de-fragmentation or garbage collection. However, such movement of the data during operations does not render the storage device as transitory because the data is not transitory while it is stored.

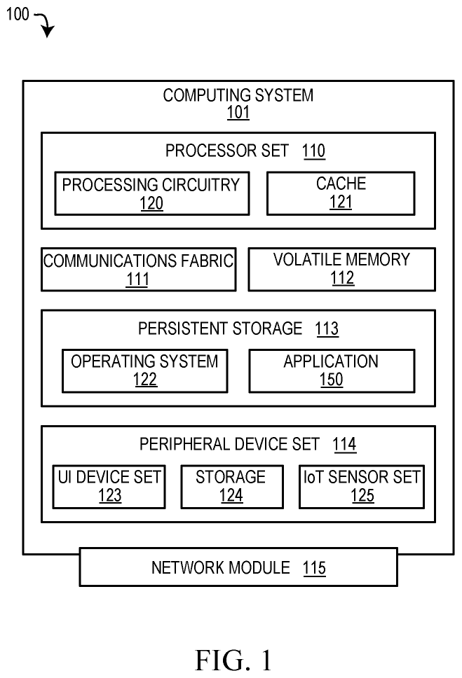

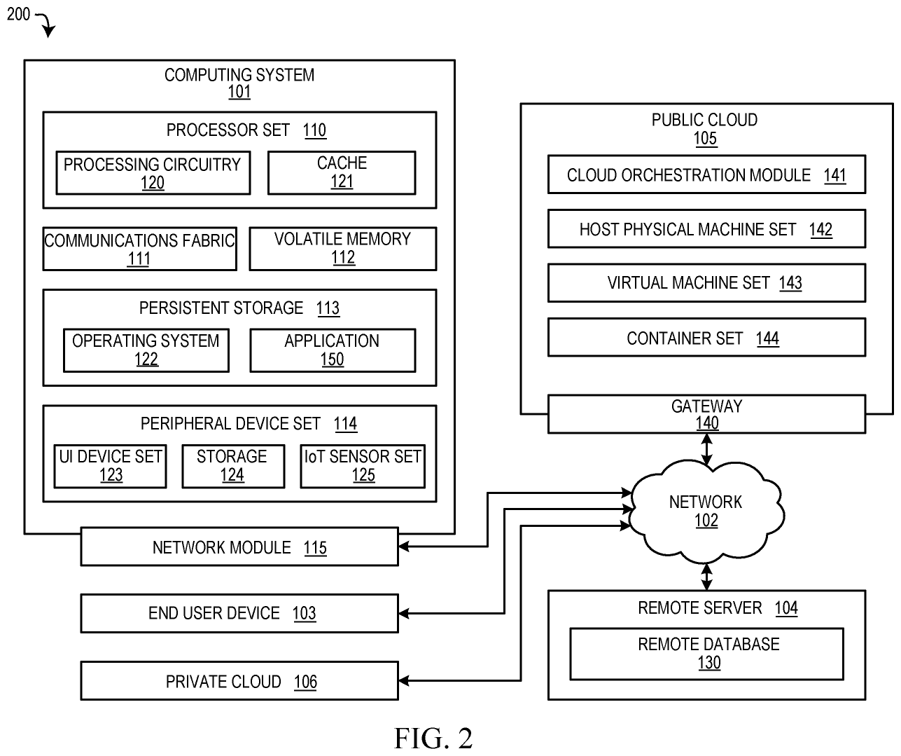

FIG. 1 illustrates a block diagram describing an embodiment of a computing system 101 operating within a computing environment 100. The computing system 101 may be a simplified example of a computing device (i.e., a physical bare metal system and/or a virtual system) capable of performing the computing operations described herein. Computing system 101 may be representative of the one or more computing systems or devices implemented in accordance with the embodiments of the present disclosure and further described below in detail. Computing system 101 as depicted in FIG. 1 (and FIG. 2) provides only an illustration of one implementation of a computing system 101 and does not imply any limitations regarding the environments in which different embodiments may be implemented. In general, the components illustrated in the computing system 101 may be representative of an electronic device, either physical or virtualized, that is capable of executing machine-readable program instructions.

Embodiments of computing system 101 may take the form of a desktop computer, laptop computer, tablet computer, smart phone or other type of mobile communications device, smart watch or other wearable computer such as a virtual reality headset, augmented reality headset, glasses or wearable accessory. Embodiments of the computing system 101 may also take the form of a mainframe computer, server, quantum computer, a non-conventional computer system such as an autonomous vehicle or home appliance, and/or any other form of computer or mobile device now known or to be developed in the future that is capable of running an application 150, accessing a network 102 or querying a database, such as remote database 130. Performance of a computer-implemented method executed by a computing system 101 may be distributed among multiple computers and/or between multiple locations. Computing system 101 may be located as part of a cloud network, even though it is not shown within a cloud in FIGS. 1-2. Moreover, computing system 101 is not required to be part of a cloud network except to any extent as may be affirmatively indicated.

Processor set 110 can include one or more computer processors of any type now known or to be developed in the future. Processing circuitry 120 may be distributed over multiple packages. For example, multiple, coordinated integrated circuit chips. Processing circuitry 120 may implement multiple processor threads and/or multiple processor cores. Cache 121 may refer to memory that is located on the processor chip package(s) and/or may be used for data or code that can be made available for rapid access by the threads or cores running on processor set 110. Cache 121 memories can be organized into multiple levels depending upon relative proximity to the processing circuitry 120. Alternatively, some, or all of cache 121 of processor set 110 may be located “off chip.” In some computing environments, processor set 110 may be designed for working with qubits and performing quantum computing.

Computer readable program instructions can be loaded onto computing system 101 to cause a series of operational steps to be performed by processor set 110 of computing system 101 and thereby implement a computer-implemented method. Execution of the instructions can instantiate the methods specified in flowcharts and/or narrative descriptions of computer-implemented methods included in this specification (collectively referred to as “the inventive methods”). The computer readable program instructions can be stored in diverse types of computer readable storage media, such as cache 121 and the other storage media discussed herein. The program instructions, and associated data, can be accessed by processor set 110 to control and direct performance of the inventive methods. In computing environments of FIGS. 1-2, at least some of the instructions for performing the inventive methods may be stored in persistent storage 113, volatile memory 112, and/or cache 121, as application(s) 150 comprising one or more running processes, services, programs and installed components thereof. For example, program instructions, processes, services and installed components thereof may include installation of route mapping service 307, diff SBOM accumulator 317, SBOB checker 319, policy repository 315 and/or SBOM repository 321, installed onto a cloud network 21, such as public cloud 105 or private cloud 106.

Communication fabric 111 may refer to signal conduction paths that may allow the various components of computing system 101 to communicate with each other. For example, communications fabric 111 can provide for electronic communication among the processor set 110, volatile memory 112, persistent storage 113, peripheral device set 114 and/or network module 115. Communication fabric 111 can be made of switches and electrically conductive paths that make up busses, bridges, physical input/output ports and the like. Other types of signal communication paths may be used, such as fiber optic communication paths and/or wireless communication paths.

Volatile memory 112 may refer to any type of volatile memory now known or to be developed in the future, and may be characterized by random access, but this is not required unless affirmatively indicated. Examples include dynamic type random access memory (RAM) or static type RAM. In computing system 101, the volatile memory 112 is located in a single package and can be internal to computing system 101, but, alternatively or additionally, the volatile memory 112 may be distributed over multiple packages and/or located externally with respect to computing system 101. Application 150, along with any program(s), processes, services, and installed components thereof, described herein, may be stored in volatile memory 112 and/or persistent storage 113 for execution and/or access by one or more of the respective processor sets 110 of the computing system 101.

Persistent storage 113 can be any form of non-volatile storage for computers that may be currently known or developed in the future. The non-volatility of this storage means that the stored data may be maintained regardless of whether power is being supplied to computing system 101 and/or directly to persistent storage 113. Persistent storage 113 may be a read only memory (ROM), however, at least a portion of the persistent storage 113 may allow writing of data, deletion of data and/or re-writing of data. Some forms of persistent storage 113 may include magnetic disks, solid-state storage devices, hard drives, flash-based memory, erasable read-only memories (EPROM) and semi-conductor storage devices. Operating system 122 may take several forms, such as various known proprietary operating systems or open-source Portable Operating System Interface type operating systems that employ a kernel.

Peripheral device set 114 includes one or more peripheral devices connected to computing system 101. For example, via an input/output (I/O interface). Data communication connections between the peripheral devices and the other components of computing system 101 may be implemented using various methods. For example, through connections using Bluetooth, Near-Field Communication (NFC), wired connections or cables (such as universal serial bus (USB) type cables), insertion type connections (for example, secure digital (SD) card), connections made though local area communication networks and/or wide area networks such as the internet. In various embodiments, UI device set 123 may include components such as a display screen, speaker, microphone, wearable devices (such as glasses, googles, headsets, smart watches, clip-on, stick-on or other attachable devices), keyboard, mouse, joystick, printer, touchpad, game controllers, and haptic feedback devices. Storage 124 can include external storage, such as an external hard drive, or insertable storage, such as an SD card. Storage 124 may be persistent and/or volatile. In some embodiments, storage 124 may take the form of a quantum computing storage device for storing data in the form of qubits. In some embodiments, networks of computing systems 101 may utilize clustered computing and/or utilize storage components as a single pool of seamless resources when accessed through a network by one or more computing systems 101. For example, a storage area network (SAN) that is shared by multiple, geographically distributed computer systems 101 or network-attached storage (NAS) applications. IoT sensor set 125 can be made up of sensors that can be used in Internet-of-Things applications. For example, a sensor may be a temperature sensor, motion sensor, light sensor, infrared sensor or any other type of known sensor type.

Network module 115 may include a collection of computer software, hardware, and/or firmware that allows computing system 101 to communicate with other computer systems through a computer network 102, such as a LAN or WAN. Network module 115 may include hardware, such as modems or Wi-Fi signal transceivers, software for packetizing and/or de-packetizing data for communication network transmission, and/or web browser software for communicating data over the network. In some embodiments, network control functions and network forwarding functions of network module 115 are performed on the same physical hardware device. In other embodiments (for example, embodiments that utilize software-defined networking (SDN)), the control functions and the forwarding functions of network module 115 can be performed on physically separate devices, such that the control functions manage several different network hardware devices or computing systems 101. Computer readable program instructions for performing the inventive methods can be downloaded to computing system 101 from an external computer or external storage device through a network adapter card or network interface which may be included as part of network module 115.

FIG. 2 depicts a computing environment 200 which may be an extension of the computing environment 100 of FIG. 1, operating as part of a network 102. In addition to computing system 101, computing environment 200 can include a computing network 102 such as a wide area network (WAN) (or another type of computer network) connecting computing system 101 to one or more end user device (EUD) 103, remote server 104, public cloud 105, and/or private cloud 106. In this embodiment, computing system 101 includes processor set 110 (including processing circuitry 120 and cache 121), communication fabric 111, volatile memory 112, persistent storage 113 (including operating system 122 and application(s) 150, as identified above), peripheral device set 114 (including user interface (UI) device set 123, storage 124, Internet of Things (IOT) sensor set 125), and network module 115. Remote server 104 includes remote database 130. Public cloud 105 can include gateway 140, cloud orchestration module 141, host physical machine set 142, virtual machine set 143, and/or container set 144.

Network 102 may be comprised of wired or wireless connections. For example, connections may be comprised of computer hardware such as copper transmission cables, optical transmission fibers, wireless transmission, routers, firewalls, switches, gateway computers and/or edge servers. Network 102 may be described as any wide area network (for example, the Internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. Other types of networks that can be used to interconnect the various computing systems 101, end user devices 103, remote servers 104, private cloud 106 and/or public cloud 105 may include Wireless Local Area Networks (WLANs), home area network (HAN), cellular networks, backbone networks (BBN), peer to peer networks (P2P), campus networks, enterprise networks, the Internet, single tenant or multi-tenant cloud computing networks, the Public Switched Telephone Network (PSTN), and any other network or network topology known by a person skilled in the art to interconnect computing systems 101.

End user device 103 can include any computer device that can be used and/or controlled by an end user (for example, a customer of an enterprise that operates computing system 101) and may take any of the forms discussed above in connection with computing system 101. EUD 103 may receive helpful and useful data from the operations of computing system 101. For example, in a hypothetical case where computing system 101 is designed to provide a recommendation to an end user, this recommendation may be communicated from network module 115 of computing system 101 through network 102 to EUD 103. In this example, EUD 103 can display, or otherwise present, the recommendation to an end user. In some embodiments, EUD 103 may be a client device, such as thin client, thick client, mobile computing device such as a smart phone, mainframe computer, desktop computer and so on.

Remote server 104 may be any computing system that serves at least some data and/or functionality to computing system 101. Remote server 104 may be controlled and used by the same entity that operates computing system 101. Remote server 104 represents the machine(s) that collect and store helpful and useful data for use by other computers, such as computing system 101. For example, in a hypothetical case where computing system 101 is designed and programmed to provide a recommendation based on historical data, the historical data may be provided to computing system 101 from remote database 130 of remote server 104.

Public cloud 105 may be any computing systems available for use by multiple entities that provide on-demand availability of computer system resources and/or other computer capabilities including data storage (cloud storage) and computing power, without direct active management by the user. The direct and active management of the computing resources of public cloud 105 can be performed by the computer hardware and/or software of cloud orchestration module 141. The computing resources provided by public cloud 105 can be implemented by virtual computing environments that run on various computers making up the computers of host physical machine set 142, and/or the universe of physical computers in and/or available to public cloud 105. The virtual computing environments (VCEs) may take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through network 102.

VCEs can be stored as “images.” A new active instance of the VCE can be instantiated from the image. Two types of VCEs may include virtual machines and containers. A container is a VCE that uses operating-system-level virtualization, in which the kernel allows the existence of multiple isolated user-space instances, called containers. These isolated user-space instances may behave as physical computers from the point of view of applications 150 running in them. An application 150 running on an operating system 122 can utilize all resources of that computer, such as connected devices, files and folders, network shares, CPU power, and quantifiable hardware capabilities. Applications 150 running inside a container of container set 144 may only use the contents of the container and devices assigned to the container, a feature which may be referred to as containerization.

Private cloud 106 may be similar to public cloud 105, except that the computing resources may only be available for use by a single enterprise. While private cloud 106 is depicted as being in communication with network 102 (such as the Internet), in other embodiments a private cloud 106 may be disconnected from the internet entirely and only accessible through a local/private network. A hybrid cloud may refer to a composition of multiple clouds of distinct types (for example, private, community or public cloud types), and the plurality of clouds may be implemented or operated by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 may be both part of a larger hybrid cloud environment.

### System for Establishing Secure Vehicle Networks

It will be readily understood that the instant components, as generally described and illustrated in the Figures herein, may be arranged and designed in a wide variety of different configurations. Accordingly, the following detailed description of the embodiments of at least one of a method, apparatus, non-transitory computer readable medium and system, as represented in the attached Figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Accordingly, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the Figures, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

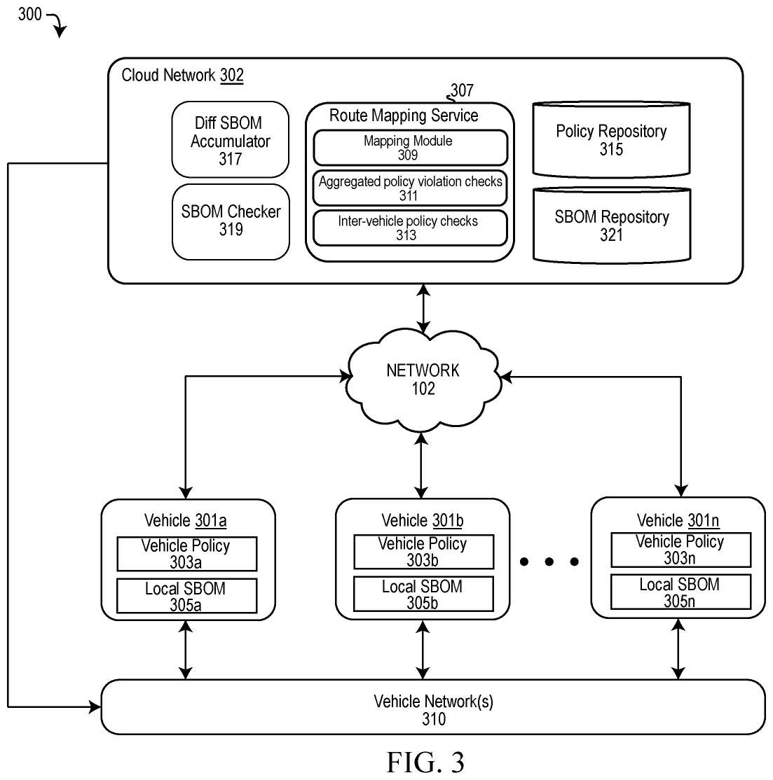

Referring to the drawings, FIG. 3 depicts an embodiment of a computing environment 300 capable of establishing secure vehicle network(s) 310 enabling one or more vehicle 301a-301n (referred to herein generally as vehicle 301 or vehicles 301) to engage in vehicle-to-vehicle communications. Embodiments of the computing environment 300 can include a plurality of networks, services, components and systems working together to establish and maintain security of one or more vehicle networks 310, ensuring that the vehicle networks 310 not only maintain proper levels of security between the participating vehicles 301, but also maintain security prescribed by policies by the surrounding environments a vehicle may be located within or traveling through at a future point in time. Including policies implemented for locations, regions or zones by government agencies and institutions.

As shown in FIG. 3, the computing environment 300 can include a plurality of vehicles 301a-301n connecting via a network 102 to one or more cloud networks 302 providing one or more applications or services to the plurality of vehicles 301. The cloud network 302 may be a private cloud 106 or a public cloud 105 as previously discussed above in the COMPUTING SYSTEM section of this disclosure. As shown in the exemplary embodiment of FIG. 3, the vehicles 301 may be using or accessing mapping services and routing information provided by a route mapping service 307 to travel to and from destinations, or to lookup directions and maps associated with a vehicle's 301 surrounding environment. Route mapping services 307 may be a program, application or service hosted by a cloud platform that allows for secure intervehicle communications over one or more vehicle networks 310 and any systems, such as vehicles 301 making use of the route maps, may apply compliance and security policies to validate a vehicle's compliance using a software bill of materials (SBOM). Route mapping service 307 (or other types of programs, services and applications, provided to vehicles 301) may be able to verify compliance with one or more policies of the regions, locations, area, zones, etc., as a vehicle 301 travels via a route provided by the route mapping service 307. Compliance with polices can be enforced by the route mapping service using information gathered from vehicle SBOMs to evaluate compliance with specific requirements for communication and for vehicles to connect to the vehicle network(s) 310. Components of the cloud network 302 that may be utilized by the route mapping service 307 to establish the vehicle network(s) 310 and compliance with policies of surrounding locations and regions can include a policy repository 315, SBOM repository 321, diff SBOM accumulator 317 and SBOM checker 319.

Embodiments of route mapping service 307 may include a mapping module 309. A “module” may refer to a self-contained component of a computing system that can perform specific computing tasks or functions. A module can be hardware, software, or a combination of both, and may be designed to be modular and easily replaceable or upgradable. With respect to a hardware module, the module can be a small circuit board that contains one or more integrated circuits (ICs) or microprocessors, as well as other components such as memory, storage, and input/output (I/O) interfaces. The module may be designed to be easily integrated into a larger system, such as an embedded system or a single-board computer. A software module may be a discrete unit of code or functionality that performs a specific task or set of tasks. Computing modules can be written in a variety of programming languages and can be designed to be reusable and easily integrated with other modules to build larger applications or systems. The mapping module 309 of the route mapping service 307 may be responsible for performing tasks and functions of route mapping service 307 directed toward collecting location information about vehicles, mapping vehicles routes, enabling or disabling vehicle connections to the vehicle network 310, validating compliance of vehicles 301 with location-enforced policies 401 and/or vehicle policy 303a-303n (referred to generally as vehicle policy 303) enforced by individual vehicles 301 communicating over vehicle network 310, as well as optimizing route maps based on vehicle compliance.

In order to validate compliance of vehicles 301 with location-enforced policies 401, route mapping service 307 may fetch SBOMs or diff SBOMs describing the software components and software dependencies for each vehicles 301. For example, fetching the SBOMs or diff SBOMs when a vehicle 301 turns on or connects to the cloud network 302. SBOMs can be stored locally (i.e., as local SBOM 305a-305n) or aggregated into the cloud network 302 as part of SBOM repository 321. An SBOM may operate by identifying and documenting all the software components and their dependencies used in a particular system or product (such as vehicle 301), including third-party and open-source software. This information can be organized in a structured format, allowing for easy tracking and analysis. An SBOM can be generated automatically using software tools that analyze the source code. Alternatively, an SBOM can be created manually by reviewing the source code and identifying the software components used. In embodiments where the vehicle 301 is an autonomous vehicle, an SBOM may include information such as the software components used in the vehicle's control systems, perception systems, and other automated functions and can be used to identify any potential security vulnerabilities or compatibility issues that may arise as a result of the software components used.

A diff-based SBOM may refer to a type of SBOM that is generated using a “diff” tool, which compares the changes made to a software system over time. A diff based SBOM can be used to track and manage changes to a software system's components and dependencies, and to identify any potential security vulnerabilities or compatibility issues that may arise as a result of those changes. By generating an SBOM based on the changes made to a software system, rather than analyzing the system as a whole, a diff based SBOM can provide a more targeted and efficient approach to managing software components and dependencies. It can also help to reduce the risk of introducing errors or vulnerabilities into the system during updates or changes. In some embodiments, route mapping service 307 may fetch diff SBOMs from one or more vehicles 301 using a diff SBOM accumulator 317.

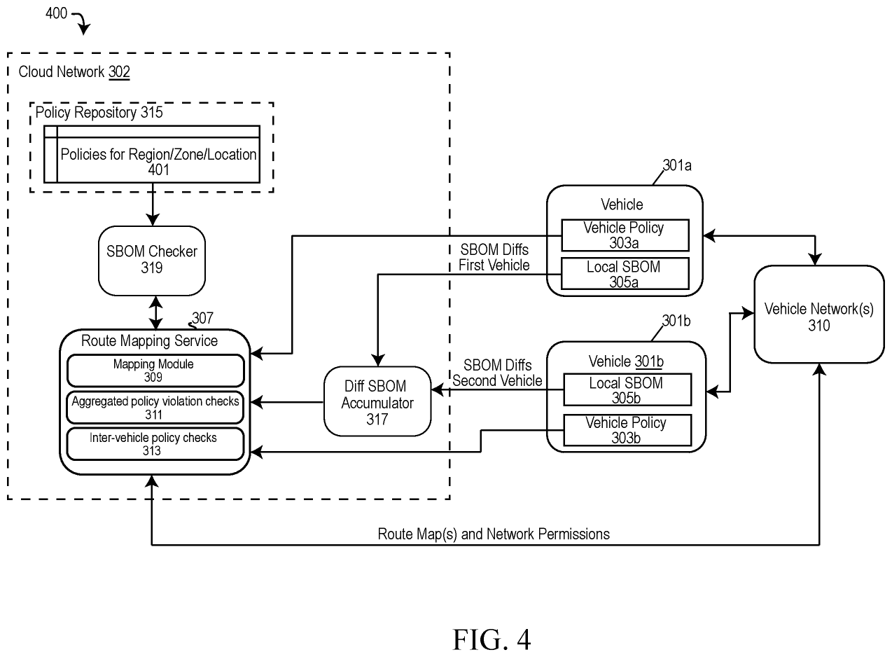

Embodiments of a diff SBOM accumulator 317 may be a tool or process that accumulates and tracks the differences between different versions of a SBOM. A situation where a diff SBOM may be fetched by the diff SBOM accumulator 317 from a vehicle 301 instead of the entire SBOM may occur whenever the vehicle performs an update or upgrade, as well as in situations when a new device may be plugged into the vehicle 301. For example, as shown in the computing environment 400 of FIG. 4, diff SBOM accumulator 317 collects diff SBOMs based on local SBOMs 305a, 305b of a first vehicle 301a and a second vehicle 301b. Moreover, if the route mapping service 307 identifies a vehicle 301 that is connecting to the cloud network 302 but is not frequently sending updates at a minimally required interval of time, the vehicle 301 that is not providing updates or upgrade information (i.e., via a diff SBOM) to the route mapping service 307, may have vehicle-to-vehicle communication disabled or may be prevented from connecting to the vehicle network 310. For example, by revoking connection credentials.

Embodiments of a diff SBOM accumulator 307 can be designed to provide a comprehensive overview of changes to the software system or product over time, allowing developers and other stakeholders to easily identify updates, upgrades, and other changes that may be relevant to security, compliance, or other considerations. The diff SBOM accumulator 307 compares different versions of the SBOM (whether locally stored as local SBOM 305a-305n and/or stored as part of SBOM repository 321) to identify any additions, deletions, or modifications in the components and dependencies used in the software system of the vehicles 301. The accumulated differences can be stored in the diff SBOM accumulator 307 and/or shared with the mapping module 309, where the diff SBOM can be used to create a timeline of changes and updates to the software system or product of the vehicle 301. The diff SBOM accumulator 317 can help identify which version of the software is currently being used and how it has evolved over time. It can also help track potential vulnerabilities, risks, and dependencies that may have been introduced with each of the changes to the software system.

SBOMs and/or diff SBOMs fetched by the route mapping service 307 can be verified for compliance to determine whether or not a vehicle 301 is compliant with the policies being enforced by a particular location, area, region, zone, 401 (referred to herein generally as “location-enforced policies 401”), that the vehicle 301 may be currently positioned within and/or routed to travel through in the future. These location-enforced policies 401 may be global policies for particular locations, regions, area, zones, etc., which may be set by government agencies or institutions, such as universities, hospitals, and facilities that may require a particular level of compliance standards. For example, an area surrounding a hospital may enforce HIPPA compliance as part of its location-enforced policy 401 and might require a level of data anonymization or encryption of data being shared or accessible by software systems of the vehicle 301. Location-enforced policies 401 may be stored within a policy repository 315 of the cloud network 302 and shared with the route mapping service, and/or may be accessible remotely to the route mapping service 307 via network 102. Embodiments of route mapping service 307 may deploy the services of SBOM checker 319 to evaluate a vehicle's compliance with the location-enforced policies 401 for the vehicle's current location and for any locations, regions, zones, area, etc., that the vehicle 301 may be currently routed by the route mapping service 307 to travel through. For example, as shown in FIG. 4, policy repository 315 shares the policies for regions, zones, locations 401 (i.e., the location-enforced policies 401) with SBOM checker 319 and outputs the results of comparing the diff SBOMs received from diff SBOM accumulator 317 against the compliancy requirements of the location-enforced policies 401.

An SBOM checker 319 may be described as a tool or process that ensures the list of components and dependencies included within an SBOM or diff SBOM are accurate, up-to-date and complete. The SBOM checker 319 can verify that all components and dependencies used by the software system of the vehicle 301 are included within the SBOM or diff SBOM and that the version numbers or other details are correct. In some embodiments, the SBOM checker can identify potential vulnerabilities or risks associated with the software system of vehicle 301 by cross-referencing the SBOM and/or diff SBOM with known security vulnerabilities or other issues in the software components and dependencies. SBOM checker 319 can verify compliance with the location-enforced policies 401 associated with the locations, areas, routes and zones along a route mapped by the route mapping service 307 by comparing the components and dependencies listed in the SBOM or diff SBOM with the policy requirements set forth by the organization or individuals in charge of setting the policy for said location. Embodiments of the SBOM checker 319 may be configured to analyze the SBOM or diff SBOM and check the SBOM or diff SBOM against the pre-defined policy rules and requirements for each specific location along a travel route, including checking the SBOM against open source license compliance, vulnerability management policies and other standards or regulations imposed by the location-enforced policies 401. SBOM checker 319 may output a report to the route mapping service 307 which may flag discrepancies or violations within the SBOM or diff SBOM that do not meet specified policy requirements for a corresponding location, area, zone, region, etc.

Embodiments of route mapping service 307 may implement one or more actions for any vehicle 301 identified by the output of the SBOM checker 319 as being in violation of one or more location-enforced policy 401 corresponding to locations, regions, zones, or areas along a route being mapped by the route mapping service 307. In some instances, mapping module 309 may mute a vehicle 301, preventing vehicle-to-vehicle communication while the vehicle is positioned within the location, area, zone, or region in which the vehicle's SBOM or diff SBOM indicates non-compliance with the local policy of that location. While muted during travel, the vehicle 301 may have network or other permissions revoked and may be unable to pair or communicate with other vehicles and/or may be unable to connect to vehicle network 310. In other situations, mapping module 309 of route mapping service 307 can re-route the vehicle to avoid the location where the vehicle 301 has been determined to fail to comply with the policy being enforced. For example, if the vehicle 301 is an automated vehicle that relies on vehicle-to-vehicle communication to accurately navigate the roadway, the route mapping service 307 may identify alternative routes that the vehicle 301 does comply with any and all location-enforced policies 401, ensuring that vehicle-to-vehicle communication will remain active during the entire duration of the vehicle's planned route. In some embodiments, the route mapping service 307 may display on a display device of the vehicle 301 possible alternative routes of travel that avoid locations, regions, zones, areas, etc. where the vehicle does not comply with the corresponding policies and thus mutes or disables the vehicle's ability for intervehicle communication. For example, displaying routes or portions of routes in red where a vehicle does not meet the compliance standards of the location-enforced policy 401 and display routes and/or portions of routes in green where the vehicle would be enabled to conduct intervehicle communication due to meeting the compliance standards of the location, region, zone, etc.

In some situations where a vehicle 301 is determined by the SBOM checker 319 to violate one or more location-enforced policies 401 along a route, embodiments of the route mapping service 307 may search for an update or upgrade to the existing software or dependencies thereof within the vehicle's SBOM or diff SBOM that, if updated or upgraded, would place the vehicle 301 in compliance with the location, region, zone or area of the route that is currently deemed non-compliant by the SBOM checker 319. Route mapping service 307 may notify the vehicle 301 about the lack of compliance with location-enforced policies 401 and inform a user of the vehicle 301 about updates or upgrades to software that would place the vehicle 301 in compliance with one or more location-enforced policies 401 of a generated route.

Upgrades or updates to software of the vehicle 301 or dependencies thereof, that would place the vehicle in compliance with a location-enforced policy 401 may be retrieved and applied to the vehicle 301. For example, in some embodiments, the upgrade or update may be applied based on travel plans ahead of implementing the scheduled route. Under such a circumstance where an update or upgrade can be applied ahead of travel, the location-based or regional muting of the vehicle 301 can be avoided altogether. In other circumstances, where a vehicle is already engaged and traveling along a generated route, if there is enough time to retrieve and apply the update or upgrade before entering the location, region, zone, etc., where the vehicle lacks compliance with the location-enforced policy 401, vehicle 301 may upgrade or update one or more software systems during the route in order to be placed into compliance and verified by SBOM checker 319. If there is not enough time to update or upgrade software systems to place the vehicle in compliance with the location-enforced policy 401, the velocity of the vehicle may be adjusted to slow the vehicle down, allowing more time to retrieve and apply the updates or upgrades to the software systems of the vehicle 301 and thus not enter the location, area, region or zone while muted. In some embodiments, vehicle 301 may even be stopped entirely in order to apply upgrades or updates before entering the location, region, area or zone. Moreover, if updating or upgrading the vehicle is not possible before arriving within a location or region without being muted or unable to engage in intervehicle communications, route mapping service 307 may change the route of the vehicle to avoid having vehicle-to-vehicle communications disabled or muted.

In some embodiments of computing environment 300, vehicle software systems of one or more individual vehicle 301 may allow drivers to set a vehicle policy 303a-303n (hereinafter referred to generally as vehicle policy 303) which can be enforced by route mapping service 307 to ensure that vehicles 301 engaged in vehicle-to-vehicle communications comply with a corresponding vehicle policy 303 of the vehicle being communicated with. Otherwise, if vehicles do not meet the level of compliance standards set by individual vehicle policies 303, route mapping service 307 may prevent the vehicles 301 from communicating with each other. For example, if one of the vehicles 301 attempting to establish intervehicle communication is an ambulance, and the ambulance's vehicle policy requires compliance with HIPPA and/or specific levels of encryption or data anonymization to be complied with in order to engage in communications, any vehicles that cannot meet the heightened level of communication requirements set by the vehicle policy of the ambulance will not be able to connect with the ambulance.

Embodiments of the route mapping service 307 may ensure compliance with individual vehicle policy 303 of vehicles 301 before establishing intervehicle communication by performing inter-vehicle policy checks 313. Similar to location-enforced policies 401, route mapping service 307 may evaluate and compare SBOMs and diff SBOMs of the vehicles 301 against specific vehicle policy 303 being enforced by at least one vehicle of the intervehicle communication attempting to be established over vehicle network 310. SBOM checker 319 may perform an inter-vehicle policy check 313 by analyzing the SBOM or diff SBOM of vehicles 301 attempting to establish vehicle-to-vehicle communication against the pre-defined vehicle policy 303 of one or more of the vehicles 301. SBOM checker 319 can verify whether each vehicle 301 meets the specified policy requirements of the other participating vehicle(s) 301. SBOM checker 319 may output a report detailing the results of the inter-vehicle policy checks 313, including flags for any discrepancies or violations in the SBOM or diff SBOM that do not meet the specified policy requirements of one or more vehicle policy 303. If one or more vehicle 301 attempting to communicate with a second vehicle does not meet the standards or requirements of a vehicle policy 303 being enforced by one or more of the vehicles attempting to establishing vehicle-to-vehicle communications, route mapping service 307 may prohibit the first vehicle and the second vehicle from establishing intervehicle communications over vehicle network 310.

In some embodiments, even if each vehicle establishing intervehicle communications over the vehicle network 310 is compliant with both location-enforced policies 401 and individual vehicle policy 303, route mapping service 307 may further ensure security of the vehicle network 310 by conducting an aggregated policy violation check 311 to ensure that the aggregated SBOMs of vehicles engaging in vehicle-to-vehicle communication are in compliance with location-enforced policies 401 of a particular location, region, zone, etc. that the vehicles may be positioned within or routed to travel through. An aggregated policy violation check may be particularly used within high security regions, such as government installations, military bases, and research hospitals. An aggregated SBOM may be a combination of multiple SBOMs or diff SBOMs that have been collected from different sources or compiled from different versions of the software system. For example, local SBOMs 305 collected from multiple vehicles and/or multiple profiles of vehicles stored as part of an SBOM repository 321. An SBOM checker 319 can be configured to analyze the aggregated SBOM and check it against predefined policy rules and requirements such as the location-enforced policies 401 of various locations, areas, regions, etc. that the vehicles 301 may be located or routed to travel through. The SBOM checker 319 can use a variety of methods to compare the aggregated SBOM with the policy requirements. For example, the tool can perform a scan of the aggregated SBOM to identify any discrepancies or violations in the listed components and dependencies that do not meet the specified policy requirements. Additionally, the SBOM checker 319 can compare the aggregated SBOM with the policy requirements of each individual SBOM that was used to compile the aggregate. This can help identify any potential issues that may arise from differences in the component lists or version numbers of the individual SBOMs.

Embodiments of SBOM checker 319 may output a report documenting any aggregated policy violations of the aggregated SBOM. Any violations described by the report outputted from SBOM checker 319 may result in route mapping service denying the establishment intervehicle communications between the plurality of vehicles 301. In some embodiments, vehicles 301 may already be engaged in vehicle-to-vehicle communications before an aggregated SBOM is checked for aggregated policy violations. For instance, vehicles may be allowed to engage in active vehicle-to-vehicle communications over vehicle network 310 for a threshold period of time before aggregated policy violation checks 311 are performed. For example, if the threshold period of time is five minutes, then upon intervehicle communications over vehicle network 310 lasting longer than five minutes, route mapping service 307 may check the aggregated SBOM of diff SBOM for compliance with location-enforced policies 401. If the aggregated policy violation check 311 returns one or more violations in the output from SBOM checker 319, route mapping service 307 may dissolve or terminate the active intervehicle communication between vehicles 301. Moreover, in some embodiments, a notification may be sent to each of the vehicles 301 indicating a warning to vehicles 301 of the aggregated policy violation and upcoming termination of the intervehicle communications due to a failure to meet an aggregated level of compliance.

In some embodiments of the route mapping service 307, the route mapping service 307 may allow drivers of vehicles 301 to set vehicle routes based on known rates of policy compliance by other vehicles 301 on the road. For example, a vehicle owner may want to only travel areas where the vehicles 301 are known to have high rates of compliance with vehicle policies 303 and/or location-enforced policies 401 and thus may set a high security and compliance alert. In response to vehicles 301 setting a high security and compliance alert, mapping module 309 may alter travel plans to route the vehicle only along routes known to have vehicles with high rates of policy compliance and may alert the driver or owner of the vehicle 301 before travel even begins. Moreover, as the compliance rate changes over time due to the change in positions of vehicles traveling across certain areas that have high compliance rates, the mapping module 309 may dynamically alter routes to ensure that the vehicle travels across routes with high compliance vehicles. In some embodiments, a display device may visually depict which routes and travel pathways have vehicles with low, medium and/or high compliance rates, as well as low, medium or high-density of vehicles known to not be in compliance with location-enforced policies 401 and/or vehicle policy 303. Visually, routes with low compliance rates and/or a dense population of low compliance vehicles may be shown in red, whereas medium levels of compliant vehicles and/or medium density of low compliance vehicles may be shown in yellow, whereas routes containing a high rate of compliant vehicles and/or a low rate of non-compliant vehicles may be shown in green. Drivers of a vehicle 301 may input via the vehicle's interface preferred routes based on the visual display and/or color-coded routes indicating levels of compliance.

### Method for Establishing Secure Vehicle Networks

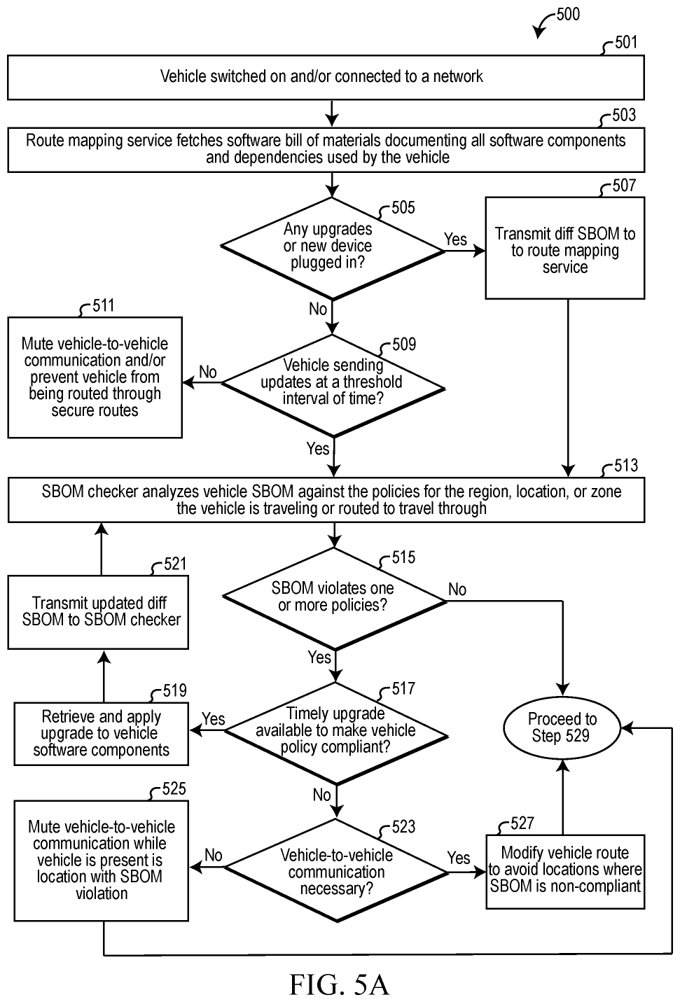

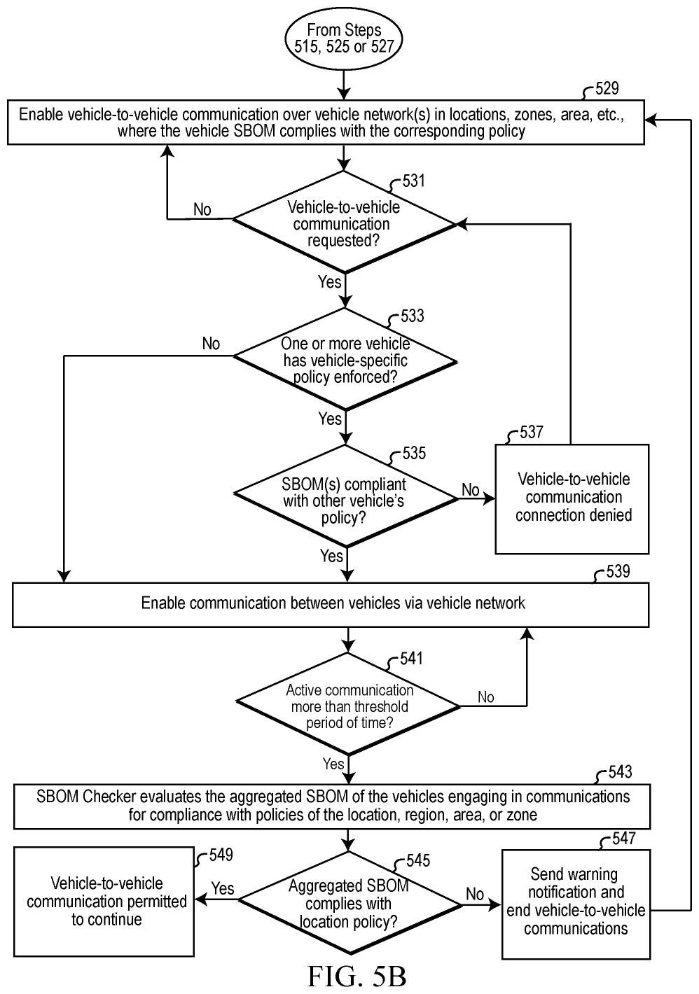

The drawings of FIGS. 5A-5B represent embodiments of methods 500 for establishing secure vehicle networks. The embodiments of method 500 can be implemented in accordance with the computing systems and examples depicted in FIGS. 1-4 above and as described throughout this application. A person skilled in the art should recognize that the steps of the method 500 described in regard to FIGS. 5A-5B may be performed in a different order than presented and may not require all the steps described herein to be performed.

The embodiments of method 500, as shown and described in FIGS. 5A-5B, may begin at step 501. During step 501, a vehicle 301 is switched on and/or connected to a network that is recognized or accessible by a route mapping service 307. At step 503, as the route mapping service 307 recognizes the presence of the vehicle 301 on the network, route mapping service 307 fetches a SBOM belonging to the vehicle 301 which documents all the software components and/or software dependencies of the vehicle 301. For example, the SBOM may be a local SBOM stored onboard the vehicle 301 locally, or available as part of a cloud network 302, for instance stored to an SBOM repository. In some instances, route mapping service 307 may deploy an SBOM accumulator or diff SBOM accumulator 317 to fetch SBOMs or diff SBOMs from the vehicle 301. During step 505, the route mapping service determines, based on the SBOM whether or not there are any upgrades to the software of vehicle 301 or whether new device is present or plugged into the vehicle that is different from the last time the route mapping service fetched the SBOM of the vehicle 301. If there are any upgrades or new devices present that result in a change to the SBOM, the method 500 may proceed to step 507, wherein the vehicle 301 may accumulate and/or transmit a diff SBOM documenting the changes to the SBOM from a previous SBOM to the route mapping service 307. Conversely, if there have not been any new upgrades or new devices added to the vehicle 301, the method may proceed to step 509.

During step 509, the route mapping service 307 may check whether or not vehicle 301 has been sending or providing updates of the SBOM for the vehicle 301 to the route mapping service 307 at a minimum of a threshold interval of time. If the vehicle is not providing SBOM updates of the vehicle 301 to the route mapping service 307 at a frequency or interval that is at least above a threshold period of time, the method 500 may proceed to step 511, wherein the route mapping service 307 may mute or disable vehicle-to-vehicle communications over a secure vehicle network 310. In some embodiments, the route mapping service 307 may prevent the vehicle 301 from being routed through one or more secured routes that may pass through certain locations, zones, area, regions, etc., that may require an elevated level of compliance from the vehicles passing through the locations. For example, a military installation or base may require a higher level of compliance that cannot be confirmed from a vehicle 301 that does not regularly provide SBOM information to the route mapping service 307 and therefore the vehicle 301 cannot be routed through the secured location. Conversely, if the vehicle 301 is sending regular SBOM updates to the route mapping service 307 within the required minimum threshold interval of time, the method 500 may proceed to step 513.

During step 513 of method 500, SBOM checker 319 may analyze the vehicle SBOM fetched during step 503 and/or the diff SBOM transmitted during step 507 against one or more policies for a region, location, zone, area, etc., where a vehicle 301 may be currently positioned or routed to drive through at some point in the future. In step 515, method 500 determines whether or not the output from SBOM checker 319 indicates that the SBOM of the vehicle 301 violates one or more of the policies corresponding to a location the vehicle 301 is currently positioned and/or routed to drive through at a future point in time. If the SBOM and/or diff SBOM do not violate one or more of the policies enforced by a location, area, zone, etc., the method 500 may proceed to step 529. Otherwise, if the output of the SBOM checker 319 indicates the SBOM or diff SBOM of vehicle 301 violates one or more policies enforced by a location, area, zone, etc., the method 500 may proceed to step 517 and may attempt to alleviate or mitigate the policy violations.

During step 517 of method 500, route mapping service 307 may detect whether or not a timely upgrade may be available which can be applied to the vehicle 301 and may make the SBOM of the vehicle compliant with the policy currently being violated. If an upgrade is available and could be timely applied before the vehicle is positioned within the location enforcing the policy that the vehicle 301 is not in compliance with, the method 500 may proceed to step 519. In some embodiments, the vehicle 301 or route mapping service 307 may modify the current route or velocity of the vehicle 301 to ensure that the vehicle is able to update or upgrade non-compliant software components before arriving at the location enforcing the policy the vehicle 301 is not compliant with. For instance, if a vehicle can slow down or stop to complete the upgrade or update, the route mapping service may advise or request the vehicle 301 to do so. During step 519, the vehicle 301 may retrieve and apply the upgrade or update to one or more software components of the vehicle 301 and upon application of the upgrade or update, the vehicle may update the SBOM based on the application of the upgrade or update. In step 521, the vehicle 301 may transmit an updated diff SBOM to the SBOM checker 319 for analysis and verification that the updated SBOM is compliant with one or more policies being enforced by a location that the vehicle 301 may have not been previously compliant with. Conversely, referring back to step 517, if a timely upgrade or update to the software components is not available that would place vehicle 301 in compliance with one or more of the location-enforced policies 401, the method 500 may proceed to step 523.

During step 523, a determination may be made by the vehicle 301 and/or route mapping service 307, whether or not vehicle-to-vehicle communication is actually necessary for the operation of the vehicle 301 attempting to connect to a vehicle network 310. If inter-vehicle communication is not necessary for the vehicle 301, method 500 may proceed to step 525, wherein the vehicle 301 is muted or denied access to the vehicle network 310 while the vehicle is present in a location enforcing a policy that the SBOM indicates the vehicle 301 is in violation. Likewise, if in step 523 it is determined that vehicle-to-vehicle communication is necessary to the operation or function of the vehicle 301 (i.e., an autonomous vehicle), method 500 may proceed to step 527, wherein route mapping service 307 can modify a route for the vehicle 301 that avoids locations where the SBOM of the vehicle is deemed to be non-compliant with the location-enforced policy 401.

During step 529 of method 500, vehicle-to-vehicle communication over a vehicle network 310 is enabled for each of the locations, zones, areas, etc., where the vehicle SBOM complies with the corresponding policies being enforced at each of said locations. In step 531, a determination is made whether or not vehicle-to-vehicle communication is requested. If inter-vehicle communication is not being requested by either the vehicle 301 or a second vehicle of the vehicle network 310, the method 500 may return to step 529 whereby the vehicle's vehicle-to-vehicle communication over the vehicle network 310 continues to remain enabled. Conversely, if vehicle-to-vehicle communication is requested, method 500 may proceed to step 533. During step 533, a determination is made by route mapping service 307 whether or not one or more of the vehicles 301 attempting to establish intervehicle communications has a vehicle-specific policy (i.e., vehicle policy 303) being enforced. If neither vehicle has a vehicle policy 303 to be enforced, method 500 may proceed to step 539 enabling communication between the vehicles 301 via vehicle network 310. However, if in step 533 one or more vehicle is enforcing a specific policy for communications with that vehicle 301, method 500 may proceed to step 535.

During step 535, SBOM checker 319 may analyze the SBOM of a first vehicle to determine whether or not the SBOM of the first vehicle is compliant with the second vehicle's policy being enforced. If the output from SBOM checker 319 indicates that the SBOM of the first vehicle is compliant with the vehicle policy 303 of the second vehicle, method 500 may proceed to step 539, and communications between the first vehicle and the second vehicle are enabled and able to actively communicate over vehicle network 310. However, if during step 535 the output from SBOM checker 319 indicates that the SBOM of the first vehicle is not compliant with the vehicle policy 303 of the second vehicle, the method proceeds to step 537, wherein vehicle-to-vehicle communication is denied and unable to occur via communication network 310.

In some embodiments, route mapping service 307 may further conduct analysis of the active or ongoing communications between vehicles 301 that are enabled in step 539. For example, as shown in FIG. 5B, method 500 may proceed from enabled communication step of step 539 and, in step 541, route mapping service 307 may assess whether or not active inter-vehicle communications have been ongoing for at least a minimum threshold period of time. If a minimum amount of time with enabled communications between vehicles has not elapsed, method 500 may proceed from step 541 back to step 539 and inter-vehicle communication over the vehicle network 310 may be allowed to continue. Conversely, if the vehicle-to-vehicle communication has occurred for at least a minimum threshold period of time, method 500 may proceed to step 543.

During step 543, SBOM checker 319 may evaluate an aggregated SBOM created by a diff SBOM accumulator 317 comprising the SBOMs of both vehicles engaging in intervehicle communications. SBOM checker 319 may be evaluating the aggregated SBOM or aggregated diff SBOM of the vehicles to ensure that the combined SBOM of the vehicles 301 in communication with one another is in compliance with the policies of the location, region, area, zone, etc. which the vehicles 301 may be currently present, or the vehicles 301 may drive through on a route mapped by the route mapping service 307. In step 545, a determination is made whether or not the output of the SBOM checker 319 indicates the aggregated SBOM of the vehicles 301 complies with one or more location-enforced policy 401. If the vehicles' aggregated SBOM is in compliance with the one or more location-enforced policy 401, method 500 may proceed to step 549, wherein the vehicle-to-vehicle communication is permitted to continue. However, if in step 545, the aggregated SBOM of the vehicles 301 engaged in intervehicle communication is not in compliance with at least one of the location-enforced policies 401, method 500 may proceed to step 547. During step 547, vehicles 301 engaged in vehicle-to-vehicle communication may receive a warning notification indicating the compliance failure or impending termination of the communications. The route mapping service may, in step 547 proceed to terminate the vehicle-to-vehicle communications.

What is claimed is:

1. A computer-implemented method for establishing a secure vehicle network, the computer-implemented method comprising:
fetching, by at least one processor, a software bill of materials (SBOM) documenting software components and dependencies of a vehicle;
comparing, by the at least one processor, the SBOM of the vehicle with one or more policies for one or more location, region or zone the vehicle is currently positioned within or routed to travel through; and
upon comparing the SBOM of the vehicle with the one or more policies, the vehicle complies with the policies of the one or more location, region or zone, enabling, by the at least one processor, vehicle-to-vehicle communication over the secure vehicle network within the one or more location, region or zone the vehicle complies with the one or more policies.

2. The computer-implemented method of claim 1, wherein upon comparing the SBOM of the vehicle with the one or more policies, the SBOM indicates the vehicle fails to comply with the one or more policies of one or more location, region or zone, the computer-implemented method further comprises:
muting, by the at least one processor, the vehicle-to-vehicle communication over the secure vehicle network while the vehicle is positioned within the one or more location, region or zone where the SBOM fails to comply with the one or more policies.

3. The computer-implemented method of claim 1, wherein upon comparing the SBOM of the vehicle with the one or more policies, the SBOM indicates the vehicle fails to comply with the one or more policies of one or more location, region or zone, the computer-implemented method further comprises:
modifying, by the at least one processor, a route of the vehicle, wherein the route bypasses the one or more location, region or zone where the vehicle fails to comply with the one or more policies.

4. The computer-implemented method of claim 1, wherein upon comparing the SBOM of the vehicle with the one or more policies, the SBOM indicates the vehicle fails to comply with the one or more policies of one or more location, region or zone, the computer-implemented method further comprises:
applying, by the at least one processor, an upgrade to one or more of the software components of the vehicle prior to the vehicle entering the one or more location, region or zone comprising the one or more policies the vehicle fails to comply with;
creating, by the at least one processor, and updated diff SBOM describing changes to the software components and dependencies of the vehicle as a result of applying the upgrade;
comparing, by the at least one processor, the updated diff SBOM of the vehicle with the one or more policies for one or more location, region or zone the vehicle is currently positioned within or routed to travel through; and
upon comparing the updated diff SBOM of the vehicle with the one or more policies, the vehicle complies with a previously failed policy corresponding to the one or more location, region or zone, enabling, by the at least one processor, vehicle-to-vehicle communication over the secure vehicle network within the one or more location, region or zone.

5. The computer-implemented method of claim 1, further comprising:
receiving, by the at least one processor, a request for vehicle-to-vehicle communication over the secure vehicle network;
comparing, by the at least one processor, the SBOM of the vehicle with a vehicle-specific policy enforced by a second vehicle of the requested vehicle-to-vehicle communication;
upon comparing the SBOM of the vehicle to the SBOM of the vehicle with a vehicle-specific policy enforced by the second vehicle, the SBOM indicates compliance with the vehicle-specific policy enforced by the second vehicle, enabling, by the at least one processor, vehicle-to-vehicle communication via the secure vehicle network between the vehicle and the second vehicle; and
upon comparing the SBOM of the vehicle to the SBOM of the second vehicle with a vehicle-specific policy enforced by the second vehicle, if the SBOM indicates a failure to comply with the vehicle-specific policy enforced by the second vehicle, denying, by the at least one processor, the request for vehicle-to-vehicle communication over the secure vehicle network.

6. The computer-implemented method of claim 5, wherein the vehicle has a vehicle-specific policy enforced by the vehicle, and upon an SBOM of the second vehicle failing to comply with the vehicle-specific policy enforced by the vehicle, the vehicle-to-vehicle communication over the secure vehicle network is denied.

7. The computer-implemented method of claim 5, wherein the vehicle-to-vehicle communication via the secure vehicle network between the vehicle and the second vehicle is enabled, the computer-implemented method further comprises:
evaluating, by the at least one processor, an aggregated SBOM comprising the SBOM of the vehicle and an SBOM of the second vehicle with the policies of the one or more location, region or zone wherein the vehicle and the second vehicle are currently positioned or routed to travel through;
upon the aggregated SBOM complying with the policies of the one or more location, region, or zone, permitting by the at least one processor, the vehicle-to-vehicle communication over the secure vehicle network; and
upon the aggregated SBOM failing to comply with the policies of the one or more location, region, or zone, terminating, by the at least one processor, the vehicle-to-vehicle communication over the secure vehicle network between the vehicle and the second vehicle.

8. A computer system for establishing secure vehicle communication networks, the computer system comprising:
at least one processor; and
a computer-readable storage media coupled to the at least one processor, wherein the computer-readable storage media contains program instructions executing, via the at least one processor, a computer-implemented method comprising:
fetching, by the at least one processor, a software bill of materials (SBOM) documenting software components and dependencies of a vehicle;
comparing, by the at least one processor, the SBOM of the vehicle with one or more policies for one or more location, region or zone the vehicle is currently positioned within or routed to travel through; and
upon comparing the SBOM of the vehicle with the one or more policies, the vehicle complies with the policies of the one or more location, region or zone, enabling, by the at least one processor, vehicle-to-vehicle communication over the secure vehicle network within the one or more location, region or zone the vehicle complies with the one or more policies.

9. The computer system of claim 8, wherein upon comparing the SBOM of the vehicle with the one or more policies, the SBOM indicates the vehicle fails to comply with the one or more policies of one or more location, region or zone, the computer-readable storage media further contains program instructions comprising:
muting, by the at least one processor, the vehicle-to-vehicle communication over the secure vehicle network while the vehicle is positioned within the one or more location, region or zone where the SBOM fails to comply with the one or more policies.

10. The computer system of claim 8, wherein upon comparing the SBOM of the vehicle with the one or more policies, the SBOM indicates the vehicle fails to comply with the one or more policies of one or more location, region or zone, the computer-readable storage media further contains program instructions comprising:
modifying, by the at least one processor, a route of the vehicle, wherein the route bypasses the one or more location, region or zone where the vehicle fails to comply with the one or more policies.

11. The computer system of claim 8, wherein upon comparing the SBOM of the vehicle with the one or more policies, the SBOM indicates the vehicle fails to comply with the one or more policies of one or more location, region or zone, the computer-readable storage media further contains program instructions comprising:
applying, by the at least one processor, an upgrade to one or more of the software components of the vehicle prior to the vehicle entering the one or more location, region or zone comprising the one or more policies the vehicle fails to comply with;
creating, by the at least one processor, and updated diff SBOM describing changes to the software components and dependencies of the vehicle as a result of applying the upgrade;
comparing, by the at least one processor, the updated diff SBOM of the vehicle with the one or more policies for one or more location, region or zone the vehicle is currently positioned within or routed to travel through; and
upon comparing the updated diff SBOM of the vehicle with the one or more policies, the vehicle complies with a previously failed policy corresponding to the one or more location, region or zone, enabling, by the at least one processor, vehicle-to-vehicle communication over the secure vehicle network within the one or more location, region or zone.

12. The computer system of claim 8, wherein the computer-readable storage media further contains program instructions comprising:
receiving, by the at least one processor, a request for vehicle-to-vehicle communication over the secure vehicle network;
comparing, by the at least one processor, the SBOM of the vehicle with a vehicle-specific policy enforced by a second vehicle of the requested vehicle-to-vehicle communication;
upon comparing the SBOM of the vehicle to the SBOM of the vehicle with a vehicle-specific policy enforced by the second vehicle, the SBOM indicates compliance with the vehicle-specific policy enforced by the second vehicle, enabling, by the at least one processor, vehicle-to-vehicle communication via the secure vehicle network between the vehicle and the second vehicle; and
upon comparing the SBOM of the vehicle to the SBOM of the vehicle with a vehicle-specific policy enforced by the second vehicle, if the SBOM indicates a failure to comply with the vehicle-specific policy enforced by the second vehicle, denying, by the at least one processor, the request for vehicle-to-vehicle communication over the secure vehicle network.

13. The computer system of claim 12, wherein the vehicle has a vehicle-specific policy enforced by the vehicle, and upon an SBOM of the second vehicle failing to comply with the vehicle-specific policy enforced by the vehicle, the vehicle-to-vehicle communication over the secure vehicle network is denied.

14. The computer system of claim 12, wherein the vehicle-to-vehicle communication via the secure vehicle network between the vehicle and the second vehicle is enabled, the computer-readable storage media further contains program instructions comprising:
evaluating, by the at least one processor, an aggregated SBOM comprising the SBOM of the vehicle and an SBOM of the second vehicle with the policies of the one or more location, region or zone wherein the vehicle and the second vehicle are currently positioned or routed to travel through;
upon the aggregated SBOM complying with the policies of the one or more location, region, or zone, permitting by the at least one processor, the vehicle-to-vehicle communication over the secure vehicle network; and
upon the aggregated SBOM failing to comply with the policies of the one or more location, region, or zone, terminating, by the at least one processor, the vehicle-to-vehicle communication over the secure vehicle network between the vehicle and the second vehicle.

15. A computer program product for establishing secure vehicle communication networks, the computer program product comprising:
one or more computer-readable storage media having computer-readable program instructions stored on the one or more computer-readable storage media, said program instructions executes a computer-implemented method comprising:
fetching, by at least one processor, a software bill of materials (SBOM) documenting software components and dependencies of a vehicle;
comparing, by the at least one processor, the SBOM of the vehicle with one or more policies for one or more location, region or zone the vehicle is currently positioned within or routed to travel through; and
upon comparing the SBOM of the vehicle with the one or more policies, the vehicle complies with the policies of the one or more location, region or zone, enabling, by the at least one processor, vehicle-to-vehicle communication over the secure vehicle network within the one or more location, region or zone the vehicle complies with the one or more policies.

16. The computer program product of claim 15, wherein upon comparing the SBOM of the vehicle with the one or more policies, the SBOM indicates the vehicle fails to comply with the one or more policies of one or more location, region or zone, the computer-readable storage media further contains program instructions comprising:
muting, by the at least one processor, the vehicle-to-vehicle communication over the secure vehicle network while the vehicle is positioned within the one or more location, region or zone where the SBOM fails to comply with the one or more policies.

17. The computer program product of claim 15, wherein upon comparing the SBOM of the vehicle with the one or more policies, the SBOM indicates the vehicle fails to comply with the one or more policies of one or more location, region or zone, the computer-readable storage media further contains program instructions comprising:
modifying, by the at least one processor, a route of the vehicle, wherein the route bypasses the one or more location, region or zone where the vehicle fails to comply with the one or more policies.

18. The computer program product of claim 15, wherein upon comparing the SBOM of the vehicle with the one or more policies, the SBOM indicates the vehicle fails to comply with the one or more policies of one or more location, region or zone, the computer-readable storage media further contains program instructions comprising:
applying, by the at least one processor, an upgrade to one or more of the software components of the vehicle prior to the vehicle entering the one or more location, region or zone comprising the one or more policies the vehicle fails to comply with;
creating, by the at least one processor, and updated diff SBOM describing changes to the software components and dependencies of the vehicle as a result of applying the upgrade;
comparing, by the at least one processor, the updated diff SBOM of the vehicle with the one or more policies for one or more location, region or zone the vehicle is currently positioned within or routed to travel through; and
upon comparing the updated diff SBOM of the vehicle with the one or more policies, the vehicle complies with a previously failed policy corresponding to the one or more location, region or zone, enabling, by the at least one processor, vehicle-to-vehicle communication over the secure vehicle network within the one or more location, region or zone.

19. The computer program product of claim 15, wherein the computer-readable storage media further contains program instructions comprising:
receiving, by the at least one processor, a request for vehicle-to-vehicle communication over the secure vehicle network;
comparing, by the at least one processor, the SBOM of the vehicle with a vehicle-specific policy enforced by a second vehicle of the requested vehicle-to-vehicle communication;
upon comparing the SBOM of the vehicle to the SBOM of the vehicle with a vehicle-specific policy enforced by the second vehicle, the SBOM indicates compliance with the vehicle-specific policy enforced by the second vehicle, enabling, by the at least one processor, vehicle-to-vehicle communication via the secure vehicle network between the vehicle and the second vehicle; and
upon comparing the SBOM of the vehicle to the SBOM of the vehicle with a vehicle-specific policy enforced by the second vehicle, if the SBOM indicates a failure to comply with the vehicle-specific policy enforced by the second vehicle, denying, by the at least one processor, the request for vehicle-to-vehicle communication over the secure vehicle network.

20. The computer program product of claim 19, wherein the vehicle-to-vehicle communication via the secure vehicle network between the vehicle and the second vehicle is enabled, the computer-readable storage media further contains program instructions comprising:
evaluating, by the at least one processor, an aggregated SBOM comprising the SBOM of the vehicle and an SBOM of the second vehicle with the policies of the one or more location, region or zone wherein the vehicle and the second vehicle are currently positioned or routed to travel through;
upon the aggregated SBOM complying with the policies of the one or more location, region, or zone, permitting by the at least one processor, the vehicle-to-vehicle communication over the secure vehicle network; and
upon the aggregated SBOM failing to comply with the policies of the one or more location, region, or zone, terminating, by the at least one processor, the vehicle-to-vehicle communication over the secure vehicle network between the vehicle and the second vehicle.
